(19) United States
(12) Patent Application Publication
(10) Pub. No.: US 2025/0059419 A1
(43) Pub. Date: Feb. 20, 2025

(54) UNDERWATER BONDING WITH A BIOBASED ADHESIVE

(71) Applicant: Purdue Research Foundation, West Lafayette, IN (US)

(72) Inventors: Jonathan J. WILKER, West Lafayette, IN (US); Gudrun SCHMIDT, West Lafayette, IN (US); Logan Joseph MILES, Lafayette, IN (US)

(21) Appl. No.: 18/720,469

(22) PCT Filed: Dec. 14, 2022
(86) PCT No.: PCT/US2022/052880

§ 371 Date: Jun. 14, 2024

Related U.S. Application Data
(60) Provisional application No. 63/290,087, filed on Dec. 16, 2021.

(51) Int. Cl. C09J 189/00; C08K 3/16; C08K 3/26; C08K 3/34; C08K 5/134; C09J 9/00

(52) U.S. Cl. CPC C09J 189/00; C08K 3/16; C08K 3/26; C08K 3/346; C08K 5/1345; C09J 9/00; C08K 2003/265

(57) ABSTRACT

Underwater adhesive compositions comprising a zein and a tannic acid, alone or further in combination with FeCl₃, an inorganic filler, a natural polymer, or any combination thereof; and a method of making them.

### CROSS-REFERENCE TO RELATED APPLICATIONS

This application claims priority to U.S. Provisional Patent Application No. 63/290,087, which was filed Dec. 16, 2021, and which is incorporated herein by reference in its entirety.

### GOVERNMENT RIGHTS

This invention was made with government support under HR0011-20-C-0019 awarded by the Department of Defense. The government has certain rights in the invention.

### TECHNICAL FIELD

This disclosure relates to bio-based adhesives suitable for wet surfaces and underwater and a method of making them.

### BACKGROUND

This section introduces aspects that may help facilitate a better understanding of the disclosure. Accordingly, these statements are to be read in this light and are not to be understood as admissions about what is or is not prior art.

Underwater bonding for adhesive is very challenging, since most adhesives do not function in water. When applied to submerged substrates, an adhesive will often interact with water prior to forming adhesive bonds with the substrate or cohesive bonds within the bulk of the adhesive. Joining of metals, plastics, or woods underwater is difficult to achieve. Methods most commonly used are welding and mechanical fasteners. The commercially available adhesives have several other drawbacks. They are petroleum-derived, toxic, and not degradable.

Protein-based adhesives are gaining considerable interest due to their unique biocompatibility and various functional groups. They are eco-friendly and possess higher strength. However, these protein-based adhesives also have a drawback. They have poor water resistance, since most proteins have many polar groups, which makes them absorb water as a boundary layer and interfacial adhesion. In addition, water also undermines the integrity of the adhesive. The effectiveness of an adhesive in dry bonding does not directly correlate with the effectiveness of the adhesive in bonding in an underwater environment. Hence, underwater or wet surface adhesion is a big concern for these protein-based adhesives.

Therefore, there is a strong need to formulate an eco-friendly, non-toxic, degradable adhesive composition which performs underwater or on a wet surface. It is an object of the present disclosure to meet such a need. This and other objects and advantages, as well as inventive features, will be apparent from the detailed description provided herein.

### SUMMARY

Provided is an underwater adhesive composition comprising (i) a zein and (ii) a tannic acid, wherein the composition comprises about 30-80 wt % of tannic acid.

In some embodiments, the adhesive composition further comprises ferric chloride (FeCl₃).

In some embodiments, the amount of zein and tannic acid used in the ratio of about 42 wt %:58 wt % of dry solid.

In some embodiments, the composition further comprises an alcohol and water and is viscous, or the composition is in a solid form.

Provided is an underwater adhesive composition comprising (i) a zein, (ii) a tannic acid, and (iii) an inorganic filler. The adhesive composition can further comprises FeCl₃.

Examples of suitable inorganic fillers include, but are not limited to, natural clay, calcium carbonate (CaCO₃), synthetic clay, or any combination thereof. Examples of natural clay include, but are not limited to, Montmorillonite (MMT-K10); Montmorillonite, dimethyl dialkyl amine (MMT-DDA or MMT-amine); and Montmorillonite, trimethyl stearyl ammonium (MMT-TSA or MMT-am). Laponite RD is a non-limiting example of a synthetic clay.

In exemplary embodiments, the amount of inorganic filler present in the adhesive composition is about 6 wt % of dry solid composition.

In some embodiments, the composition further comprises an alcohol and water and is viscous, or the composition is in a solid form.

Further provided is, an underwater adhesive composition comprising (i) a zein, (ii) a tannic acid, (iii) an inorganic filler, and (iv) a natural polymer. The adhesive composition can further comprises FeCl₃.

In some embodiments, the composition further comprises an alcohol and water and is viscous, or the composition is in a solid form.

In some embodiments, the natural polymer used in the adhesive composition can be a protein or a polysaccharide. Examples of a polysaccharide include, but are not limited to, cellulose derivatives such as (hydroxypropyl)methyl cellulose (HPM), methylcellulose (M Cell), α-cellulose (α Cell), and Avicel PH-101. Examples of a protein include, but are not limited to, casein, albumin, soy, gelatin, mucin, and any combination thereof. The soy protein can be selected from soybean flour, soy protein isolate, and soy protein acid hydrolysate. In various embodiments, casein can be a preferred protein.

In exemplary embodiments, the inorganic filler and the natural polymer are in a ratio of about 1:1 wt/wt.

Examples of suitable inorganic fillers include, but are not limited to, natural clay, calcium carbonate (CaCO₃), synthetic clay, or any combination thereof. Examples of natural clay include, but are not limited to, Montmorillonite (MMT-K10); Montmorillonite, dimethyl dialkyl amine (MMT-DDA or MMT-amine); and Montmorillonite, trimethyl stearyl ammonium (MMT-TSA or MMT-am). Laponite RD is a non-limiting example of a synthetic clay.

Still further provided is, an underwater adhesive composition comprising (i) a zein, (ii) a tannic acid, and (iii) a natural polymer. The adhesive composition further comprises FeCl₃.

In some embodiments, the composition further comprises an alcohol and water and is viscous, or the composition is in a solid form.

The natural polymer used in the adhesive composition can be a protein or a polysaccharide. Examples of a polysaccharide include, but are not limited to, cellulose derivatives such as (hydroxypropyl)methyl cellulose (HPM), methylcellulose (M Cell), α-cellulose (α Cell), and Avicel PH-101. Examples of a protein include, but are not limited to, casein, albumin, soy, gelatin, mucin, or any combination thereof. The soy protein can be selected from soybean flour, soy protein isolate, and soy protein acid hydrolysate. In various embodiments, casein can be a preferred protein.

Still further provided is a method of preparing an underwater adhesive composition comprising a zein and a tannic acid, which method comprises:
a. mixing a zein stock solution with a tannic acid, in the presence of an alcohol to obtain a highly viscous formulation;
b. adjusting the pH to about 8-11; and
c. mixing the highly viscous formulation with an inorganic filler alone or in combination with a natural polymer in the presence of alcohol to obtain a coacervate or a paste or a putty like adhesive composition.

The method can further comprises adding FeCl₃ in step (a). In exemplary embodiments, the zein stock can be prepared by mixing a zein with a solution containing alcohol and water and adjusting the pH of the zein stock solution to 8-11. Alcohol can be any suitable alcohol. In various embodiments, ethanol can be a preferred alcohol.

### BRIEF DESCRIPTION OF DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1a shows an adhesive performance of an underwater adhesive composition in solution form comprising (i) zein, (ii) tannic acid, and (iii) ethanol and water. Aluminum, stainless steel, and bronze were used as substrates. The adhesive composition was applied under ocean water onto the substrates and left for 24 hours before lap shear testing. The figure shows adhesion strength (y-axis) versus tannic acid composition (x-axis: tannic acid content). The x-axis represents the concentration of tannic acid in wt % of dry solid. Zero tannic acid represents the zein-only control. The trends in adhesion are similar for all substrates tested, and adhesion maxima are observed around the same composition of zein and tannic acid.

FIG. 1b shows the underwater adhesive performance of the strongest adhesive composition comprising (i) zein, and (ii) tannic acid where the concentration of tannic acid can be around 58-60 weight % of dry solid. The adhesive composition and control composition comprising only zein were applied under ocean water onto the substrates and left there for 24 hours before lap shear testing. Seven substrates were compared to each other for the same strongest adhesive composition and the same zein-only control. Y-axis represents the adhesion strength and x-axis represents the substrates.

FIG. 2 shows the underwater adhesive performance of the adhesive composition comprising (i) zein, (ii) tannic acid, (iii) calcium carbonate (CaCO₃), (iv) casein, and (v) FeCl₃. Bronze was used as substrate. Samples were left in ocean water for 24 hours (circle), one week (square), and two weeks (triangle) before lap shear testing was performed. The figure describes the adhesion strength (y-axis) versus a variety of adhesive compositions (x-axis) and controls listed by “sample number”. The “sample number” corresponds to the composition as listed in the Table 1.

FIG. 3a shows the adhesive composition comprising (i) zein, (ii) tannic acid, (iii) CaCO₃, (iv) casein, and (v) FeCl₃ right after sample preparation and, when the adhesive composition paste is plunged into salt water, a skin is immediately formed around the glue that protects the inside composition from “curing”. This paste can be applied underwater to a substrate. After a few days in salt water, the glue becomes hard and brittle.

FIG. 3b shows the adhesive composition applied under saltwater on bronze. After lap shear testing, the adhesive composition remained on both sides of the adherends suggesting cohesive failure.

FIG. 4a shows the underwater adhesive performance of an adhesive composition comprising (i) zein, (ii) tannic acid, (iii) inorganic filler, and (iv) FeCl₃. Bronze was used as substrate. The lap shear testing was done in salt water after 24 hours, one week, and two weeks. The figure describes the adhesion strength (y-axis) versus the name and type of inorganic filler used in the adhesive composition (x-axis).

FIG. 4b shows the underwater (salt water) performance of adhesive compositions comprising (i) zein, (ii) tannic acid, (iii) Montmorillonite clay, such as MMT-am, and (iv) FeCl₃. The concentration of MMT-am varied from about 0.1 g to about 0.45 g. lap shear testing was done after 24 hours, and one week in salt water using various substrates, such as wood, steel, bronze, aluminum, polytetrafluoroethylene (PTFE), and polypropylene (PP).

FIG. 5 shows the underwater adhesive performance of an adhesive composition comprising a ratio of zein 42 wt % of dry solid:tannic acid 58 wt % of dry solid content, ethanol, and water in a different type of water. The substrate was bronze, and the temperature was kept at 21° C. The y-axis represents the adhesion strength values, and the x-axis represents water type and “time spent in water.”

FIG. 6a shows the underwater adhesive performance of an adhesive composition comprising (i) zein, (ii) tannic acid, and (iii) protein, such as a soy derivative.

FIG. 6b shows the underwater adhesive performance of an adhesive composition comprising (i) zein, (ii) tannic acid, and (iii) polysaccharide, such as a cellulose derivative.

FIG. 7a shows the underwater adhesive performance of an adhesive composition comprising (i) zein, (ii) tannic acid, and (iii) protein, such as casein, albumin, gelatin, and mucin, and (iv) FeCl₃.

FIG. 7b shows the underwater adhesive performance of an adhesive composition comprising (i) zein, (ii) tannic acid, and (iii) inorganic fillers, such as differently treated Laponite clays, Montmorillonite clays, and calcium carbonate versions.

FIG. 8 shows a comparison of underwater adhesive performances of adhesive compositions applied to substrates under ocean water and left for 24 hours before lap shear testing, and on benchtop and then immediately placed underwater and kept there for 24 hours. The substrates tested include wood, steel, bronze, PP, PTFE, and limestone.

FIG. 9 shows the temperature-dependent underwater adhesive performance of an adhesive composition comprising a ratio of zein 42 wt %:tannic acid 58 wt % (dry solid content), and ethanol/water in ocean water. The substrates were bronze, and the temperatures ranged from about 5-60° C. The adhesion strength values (y-axis) versus water temperature is shown. Data were obtained from lap shear testing of samples kept in ocean water for 24 hours. The adhesive was applied underwater.

### DETAILED DESCRIPTION

For the purposes of promoting an understanding of the principles of the present disclosure, reference will now be made to the embodiments illustrated in the drawings, and specific language will be used to describe the same. No limitation of scope is intended by the description of these embodiments. On the contrary, this disclosure is intended to cover alternatives, modifications, and equivalents as may be included within the spirit and scope of this application as defined by the appended claims.

The term “about” can allow for a degree of variability in a value or range, for example, within 10%, within 5%, or within 1% of a stated value or of a stated limit of a range.

The term “substantially” can allow for a degree of variability in a value or range, for example, within 90%, within 95%, or within 99% of a stated value or of a stated limit of a range.

The terms “a,” “an,” or “the” are used to include one or more than one unless the context clearly dictates otherwise. The term “or” is used to refer to a nonexclusive “or” unless otherwise indicated. In addition, the phraseology or terminology employed herein, and not otherwise defined, is for the purpose of description only and not of limitation. Any use of section headings is intended to aid reading of the document and is not to be interpreted as limiting. Further, information that is relevant to a section heading may occur within or outside of that particular section. The terms “including” and “having” are open ended terms like comprising (i.e., open language).

The term “zein” refers to a prolamine, which is an alcohol-soluble protein present in corn.

The term “lap shear testing” refers to testing that measures the ability of a material to withstand stresses set in a plane, where the exerted shear force is moving the two substrates in opposite directions. Lap shear strength is evaluated based on the ASTM D1002 test procedure.

The terms “underwater adhesive composition”, “adhesive composition”, and “adhesive” are used interchangeably.

The term “underwater adhesion” refers to applying the adhesive underwater when both substrates are underwater and providing underwater bonding. It is to be understood, however, that the term encompasses application of the adhesive under wet conditions, i.e., when both substrates are wet, but when either one or both substrates is/are not submerged under water, and providing bonding under such wet conditions.

The present disclosure relates to protein-based adhesive compositions, which bond strongly underwater. The compositions provide strong adhesion on substrates entirely submerged underwater and on the wet surface. They are fully biobased and require no chemical synthesis.

The adhesive compositions that work in dry environment do not work when applied underwater or on wet surfaces. It is well known in art that dry adhesive compositions do not show strong bonding underwater or on wet surfaces.

Provided is an underwater adhesive composition comprising (i) a zein and (ii) a tannic acid, wherein the composition comprises about 30-80 wt % of tannic acid.

Zein can be any suitable zein. In exemplary embodiments, zein is a hydrophobic protein obtained from corn. It is soluble in alcohol and a little water but insoluble in water alone. It has a high percentage of nonpolar and neutral amino acid residues, like proline, leucine, alanine, and glutamine, which provides excellent water resistance to zein-based adhesives.

In some embodiments, the adhesive composition further comprises ferric chloride (FeCl₃).

FeCl₃ can be added for additional cross-linking and better handling of the adhesive. Coordination bonding between Fe⁺³ from FeCl₃ and a hydroxyl group from one or more tannic acids can lead to reversible cross-linking that increases cohesion and adhesion properties of the adhesive composition of the disclosure. It can lead to better adhesion to metal adherents.

The composition further comprises alcohol and water and is viscous, wherein the viscosity of the composition ranges from low to high. After curing underwater, the composition can be in a dry solid form and comprise some water. In various embodiments, ethanol can be a preferred alcohol.

The amount of tannic acid used in the adhesive composition can be higher than zein. Zein can act as the matrix or binder that crosslinks and holds the tannic acid molecules together. The compositions high in tannic acid concentrations stick well underwater or on the wet surface and cannot be easily removed.

Table 1 shows the underwater adhesives composition comprising zein and tannic acid in different ratios. The amount of zein and tannic acid can be in grams, where the adhesive composition is in the thick or thin solution form comprising ethanol and water, whereas the amount of zein and tannic acid can be in wt % of dry solid, where the adhesive composition is in dry solid form. The underlined composition in bold shows maximum adhesion.

TABLE 1

| | |
|---|---|
| Adhesive in ca. 5 g | Dry Solid Content |
| Ethanol-Water | or Ratio |

| Zein | Tannic Acid | Zein | Tannic Acid |
|---|---|---|---|
| g | g | wt % | wt % |
| 2.2 | 0 | 100 | 0 |
| 2.2 | 1.0 | 68.75 | 31.25 |
| 2.2 | 2.0 | 52.38 | 47.62 |
| 2.2 | 3.0 | 42.31 | 57.69 |
| 2.2 | 4.0 | 35.48 | 64.52 |
| 2.2 | 5.0 | 30.56 | 89.68 |

In some embodiments, tannic acid can be present in an amount in the range of about 30 wt % to about 80 wt % (e.g., about 30 wt % to 80 wt %, 30 wt % to about 80 wt %, or 30 wt % to 80 wt %) of dry solid content of the composition. In certain embodiments, which can be preferred embodiments, tannic acid can be present in an amount of about 58 wt % (e.g., 58 wt %) of dry solid content of the composition. In some embodiments, zein can be present in an amount in the range of about 70 wt % to about 20 wt % (e.g., about 20 wt % to 70 wt %, 20 wt % to about 70 wt %, or 20 wt % to 70 wt %) dry solid content of the composition. In certain embodiments, which can be preferred embodiments, zein can be present in an amount of about 42 wt % (e.g., 42 wt %) of dry solid content of the composition.

In some embodiments, such as when the adhesive composition is in a dry solid form, the adhesive composition can comprise the ratio of zein to tannic acid of about 42 wt %:58 wt % of dry solid content, or 42 wt %:58 wt % of dry solid content. This composition showed the best adhesion performance on bronze, aluminum, and steel substrates at 20° C.

In some embodiments, such as when the adhesive composition is in thick or thin solution form, the adhesive composition can comprise the ratio of zein to tannic acid of about 2 g:3 g, or 2 g:3 g. This composition showed the best adhesion performance on bronze, aluminum, and steel substrates at 20° C.

In some embodiments, provided is a method to prepare the underwater adhesive composition comprising a zein and a tannic acid, wherein the method comprises mixing a zein stock solution with the tannic acid in the presence of alcohol to obtain a highly viscous formulation.

The zein stock solution can be prepared by mixing a zein with a solution containing alcohol and water and adjusting the pH of the zein solution to 8-11 using an inorganic base. The inorganic base can be any suitable inorganic base. Inorganic base can be selected from NaOH, KOH, Na₂CO₃, CaCO₃, K₂CO₃ etc. In various embodiments, ethanol can be a preferred alcohol.

The zein stock solution can be, and desirably is, clear and highly viscous. The resulting underwater adhesive composition can be, and desirably is, a coacervate or a paste or a putty like or a thick solution/dispersion.

The order and addition of individual components can influence the quality of the adhesive composition. The use of an ethanol and water solution in step (a) is a vital factor since zein is insoluble in water. If the water is added first and then ethanol, it will lead to a heterogeneous mixture or a slurry, which can harden zein clumps, which are difficult to dissolve.

The prepared gum-like adhesive composition was applied onto the substrates under salt water, and adherents were left there for 24 hours before lap shear testing. The composition became hard/brittle after 24 hours in salt water.

Examples of the substrate onto which the adhesive composition can be applied include, but are not limited to, bronze, aluminum, stainless steel, wood, limestone, polytetrafluoroethylene (PTFE), and polypropylene (PP).

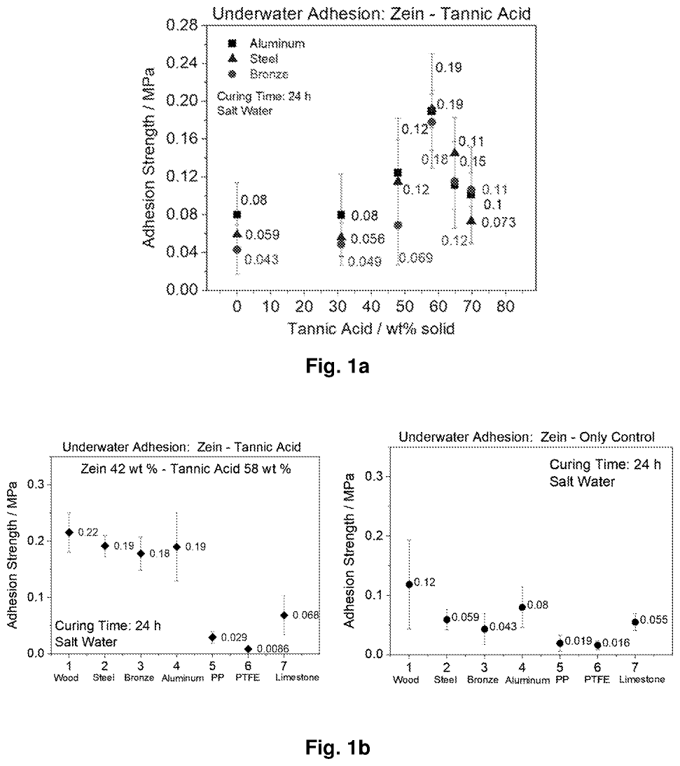

The adhesion strength of the adhesive composition can be independent of the metal substrate (see FIG. 1a). The adhesion maxima were observed for a composition comprising 42 wt % dry solid of zein and 58 wt % dry solid of tannic acid (i.e., 2.2 g zein and 3.0 g tannic acid in solution form) for all the substrates. For example, for aluminum substrate, the adhesion was maximum, whereas, for lower tannic acid compositions, the adhesion strength was maximum for bronze. The adhesive is easier to apply to the bronze substrate than other metals. The underwater adhesive performance for the composition was best on aluminum. Stainless steel adherents were heavy, and lap shear testing data were harder to collect when the adhesives were weak. The maximum adhesion was obtained with the adhesive composition comprising about 58 wt % dry solid of tannic acid (3 g in viscous solution form).

FIG. 1b shows that, on average, wood substrates performed as well as the metals. Polymers, such as PTFE and PP surfaces, displayed only weak adhesion, but the values measured and calculated were still a little bit stronger than the zein only control. For limestone, the zein-tannic acid formulation and the zein only control performed equally well. Taken together, these additional data show how much better the best tannic acid-zein formulation compares to the zein-only control.

In some embodiments, provided is an underwater adhesive composition comprising (i) a zein, (ii) a tannic acid, (iii) an inorganic filler, and (iv) a natural polymer.

In some embodiments, the adhesive composition can further comprises FeCl₃.

The adhesive composition can further comprises alcohol and water and is viscous, wherein the viscosity of the composition ranges from low to high or the composition is in a solid form.

The addition of an inorganic filler can help improve the strength of underwater and on wet surface adhesion. For example, the inorganic filler can form bonds between proteins. The inorganic filler can also increase the viscosity of the adhesive composition. Examples of suitable inorganic fillers include, but are not limited to, natural clay, calcium carbonate (CaCO₃), synthetic clay, or any combination thereof. Examples of natural clay include, but are not limited to, Montmorillonite (MMT-K10); Montmorillonite, dimethyl dialkyl amine (MMT-DDA or MMT-amine); and Montmorillonite, trimethyl stearyl ammonium (MMT-TSA or MMT-am). Laponite RD is a non-limiting example of a synthetic clay.

MMT-DDA and MMT-TSA are natural Montmorillonite clays with a surface modified with 35-45 wt % dimethyl dialkyl amine and 25-30 wt % trimethyl stearyl ammonium, respectively. CaCO₃ can be used as an inorganic filler. CaCO₃ can be selected from marble white 200 Limestone (MW-200) and marble white 325 Limestone (MW-325).

The natural polymer used in the adhesive composition can be a protein or a polysaccharide. Examples of a polysaccharide include, but are not limited to, cellulose derivatives such as (hydroxypropyl)methyl cellulose (HPM), methylcellulose (M Cell), α-cellulose (α Cell), and Avicel PH-101. Examples of a protein include, but are not limited to, casein, albumin, soy, gelatin, mucin, or any combination thereof. The soy protein can be selected from soybean flour, soy protein isolate, and soy protein acid hydrolysate. In various embodiments, casein can be a preferred protein.

In some embodiments, the amounts of CaCO₃ and casein can be used in a ratio ranging from about 0.1:10 to about 10:0.1. In various embodiments, a ratio of about 1:1 (e.g., 1:1) can be preferred. The phosphate group of casein can help hold the composition together by forming a bond with CaCO₃.

Table 2 shows the underwater adhesive compositions comprising (i) zein, (ii) tannic acid, (iii) inorganic filler, such as CaCO₃, (iv) protein, such as casein, and (v) FeCl₃. The composition can comprise CaCO₃ and casein in various wt % but always in a ratio of about 1:1 (e.g., 1:1).

TABLE 2
The zein stock solution comprises 55.5 g zein powder, 45 g ethanol (95%), 23 g distilled
water, and 4.0 g NaOH (10M; used to adjust pH to pH = 8-11 as measured with pH paper).

| | Starting glue = | | | | |
|---|---|---|---|---|---|
| | same for all | CaCO₃ | | Weight % components in | |
| No. | formulations | (200) | Casein | dry glue, estimated | Final product |
| 1 | 5.0 g zein stock | | | 2.19 g zein dry in stock solution; | Control; |
| | solution (zein SS) | | | 36.5 wt % dry zein in dry glue | translucent |
| | 1.0 g tannic acid | | | Glue never dries in seawater | amber, pH = 9 |
| | 0.001 g FeCl₃ | | | | |
| 2 | 5.0 g zein SS | 0.2 g | | 35.3 wt % dry zein in dry glue; | Control; |
| | 1.0 g tannic acid | | | 3.22 wt % dry CaCO₃ | Opaque beige |
| | 0.001 g FeCl₃ | | | | |
| 3 | 5.0 g zein SS | | 0.2 g | 35.3 wt % dry zein in dry glue | Control |
| | 1.0 g tannic acid | | | 3.22 wt % dry casein | |
| | 0.001 g FeCl₃ | | | | |
| 4 | 5.0 g zein SS | 0.2 g | 0.2 g | 34.2 wt % dry zein in dry glue | flowing paste; |
| | 1.0 g tannic acid | | | 3.12 wt % dry CaCO₃ | hard to apply in |
| | 0.001 g FeCl₃ | | | 3.12 wt % dry casein | salt water |
| 5 | 5.0 g zein stock | 0.5 g | 0.5 g | 31.3 wt % dry zein in dry glue | flowing paste |
| | solution | | | 7.14 wt % dry CaCO₃ | |
| | 1.0 g tannic acid | | | 7.14 wt % dry casein | |
| | 0.001 g FeCl₃ | | | | |
| 6 | 5.0 g zein SS | 1.0 g | 1.0 g | 27.4 wt % dry zein in dry glue | flowing paste, |
| | 1.0 g tannic acid | | | 12.5 wt % dry CaCO₃ | strongest glue |
| | 0.001 g FeCl₃ | | | 12.5 wt % dry casein | |
| 7 | 5.0 g zein SS | 2.0 g | 2.0 g | 21.9 wt % dry zein in dry glue | thick paste; |
| | 1.0 g tannic acid | | | 20.0 wt % dry CaCO₃ | easy to apply, |
| | 0.001 g FeCl₃ | | | 20.0 wt % dry casein | pH = 4 |
| 8 | 5.0 g zein SS | 3.0 g | 3.0 g | 18.2 wt % dry zein in dry glue | Paste; thickens |
| | 1.0 g tannic acid | | | 25 wt % dry CaCO₃ | after 20 min., |
| | 0.001 g FeCl₃ | | | 25 wt % dry casein | easy to apply in |
| | | | | | salt water, pH = |
| | | | | | 4 |

In various embodiments, the strongest underwater adhesive composition can comprise zein:CaCO₃:casein in a ratio of about 27.4 wt % of dry solid:12.5 wt % of dry solid:12.5 wt % of dry solid.

This adhesive composition shows strong adhesion on a metal substrate. Examples of metal substrates include, but are not limited to, bronze, aluminum, and stainless steel. Preferably, the substrate used is bronze. The metal substrate, which is least affected by salt water, is bronze. The synthetic polymers, such as PP and PTFE, can also work well as substrates under salt water.

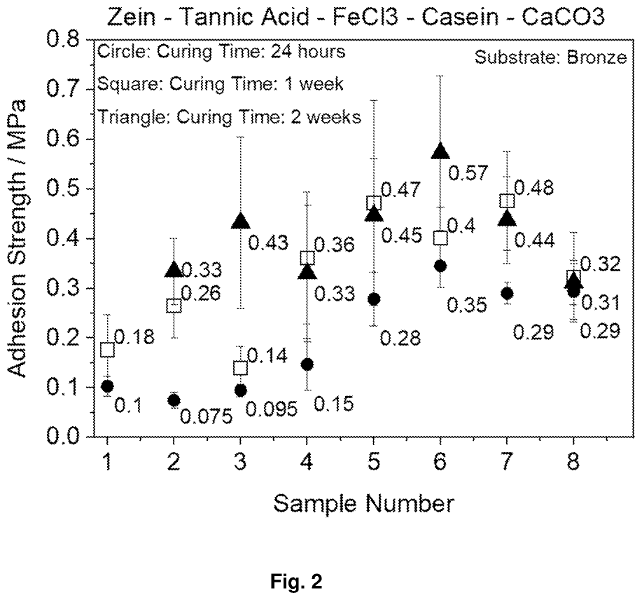

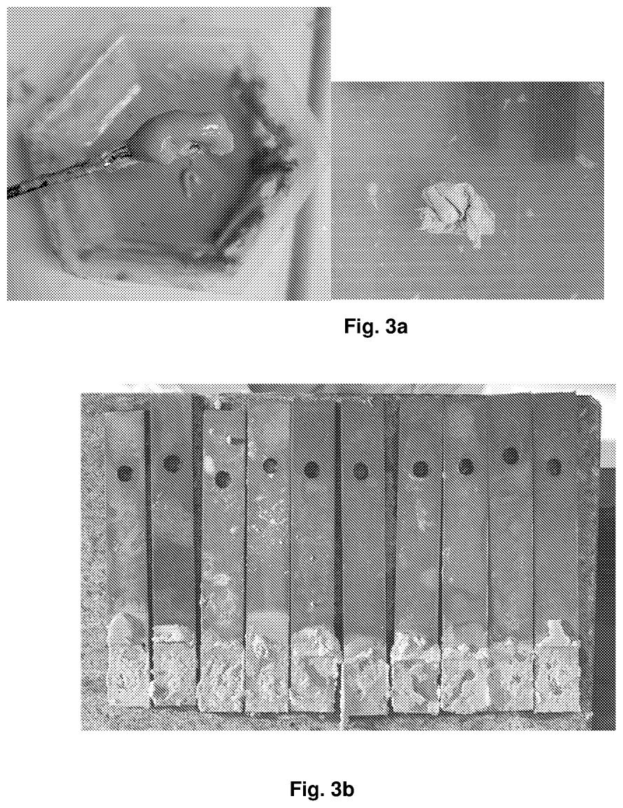

FIG. 2 shows the adhesive performance of the underwater adhesive compositions listed in Table 2. After lap shear testing, adhesive remained on both sides of the adherends (see FIG. 3b), suggesting cohesive failure. When a spatula full of highly viscous adhesive is plunged into salt water, a skin is immediately formed around the adhesive that protects the inside from phase separating and from the “curing” process (FIG. 3a). Different adhesive compositions that can represent coacervates/pastes/putties can be easily applied underwater or on the wet surface to metal substrates. Lower viscous solutions (when compared to pastes) can be applied better to polymer substrates. After a few days in salt water, the glue becomes hard and brittle.

In some embodiments, further provided is an underwater adhesive composition comprising (i) a zein, (ii) a tannic acid, and (iii) an inorganic filler.

In some embodiments, the adhesive composition can further comprises FeCl₃.

The composition can still further comprises alcohol and water and is viscous, wherein the viscosity of the composition ranges from low to high or is in a solid form.

The inorganic fillers that can improve water resistance and enhance adhesion are selected from natural clays, CaCO₃, synthetic clays, or any combination thereof. Examples of natural clay include, but are not limited to, MMT-K10, MMT-DDA or MMT-amine, and MMT-TSA or MMT-am. Laponite RD is a non-limiting example of a synthetic clay. Example sources of CaCO₃ include, but are not limited to, marble white limestone MW-200 or MW-325.

The inorganic filler can be present in an amount in the range of about 0.1 wt % to about 60 wt %, such as about 0.1 wt % to 60 wt %, 0.1 wt % to about 60 wt %, or 0.1 wt % to 60 wt %, of dry solid content. In various embodiments, about 6 wt % (e.g., 6 wt %) of dry solid content can be preferred.

Table 3 shows the underwater adhesive composition comprising the inorganic filler in various wt % amounts.

TABLE 3

| In ca. 5-10 g Ethanol-Water | | | Dry Solid Content or Ratio | | |
|---|---|---|---|---|---|
| Zein, | Tannic Acid, | Inorg. | Zein | Tannic Acid | Inorg. Filler |
| g | g | Filler, g | wt % | wt % | wt % |
| 2.2 | 3 | 0 | 42.31 | 57.69 | 0.00 |
| 2.2 | 3 | .01 | 42.23 | 57.58 | 0.19 |
| 2.2 | 3 | .05 | 41.90 | 57.14 | 0.95 |
| 2.2 | 3 | 0.1 | 41.51 | 56.60 | 1.89 |
| 2.2 | 3 | 0.5 | 38.60 | 52.63 | 8.77 |
| 2.2 | 3 | 1 | 35.48 | 48.39 | 16.13 |
| 2.2 | 3 | 2 | 30.56 | 41.67 | 27.78 |
| 2.2 | 3 | 3 | 26.83 | 36.59 | 36.59 |
| 2.2 | 3 | 4 | 23.91 | 32.61 | 43.48 |
| 2.2 | 3 | 5 | 21.57 | 29.41 | 49.02 |
| 2.2 | 3 | 6 | 19.64 | 26.79 | 53.57 |
| 2.2 | 3 | 7 | 18.03 | 24.59 | 57.37 |
| 2.2 | 3 | 8 | 16.67 | 22.72 | 60.60 |

The adhesive composition can be prepared by mixing a zein stock solution, a tannic acid, an inorganic filler, and FeCl₃ in an aqueous alcoholic solvent, such as ethanol. The zein stock solution can be prepared by dissolving a zein powder in an aqueous solution of ethanol (ethanol+water) and adjusting the pH of the solution to about 8-11 using a pH modifier, such as a sodium hydroxide (NaOH) solution.

The substrate onto which the adhesive composition is applied can be a wood, a metal substrate, or a synthetic polymer. Examples of metal substrates include, but are not limited to, bronze, stainless steel, and aluminum. Preferably, the metal substrate is bronze. The bronze is least affected by salt water. The synthetic polymers are selected from PP and PTFE.

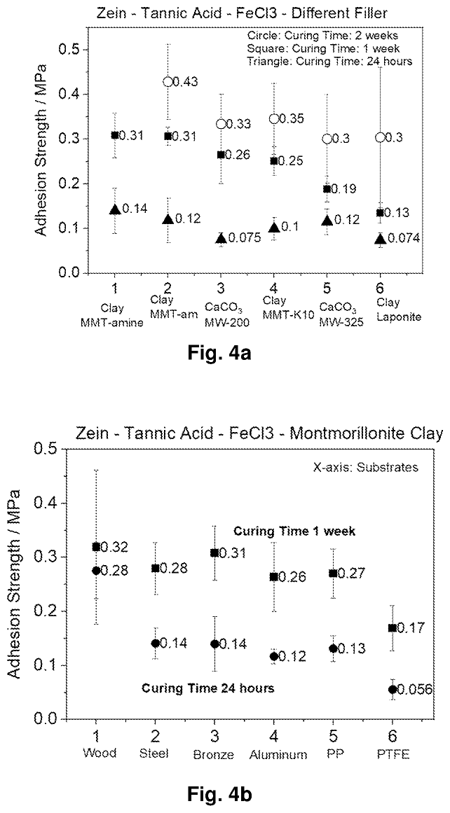

Lap shear testing was done after the substrate on the application of the composition was kept for 24 hours, one week, and two weeks in salt water (see FIG. 4a). For the adhesive composition comprising zein-tannic acid-MMT-am clay, the highest adhesive performance, after two weeks in salt water, was around 0.4 Mpa. Adhesive strength can depend on the concentration of MMT-am clay and the material of the substrate. FIG. 4a shows that the underwater adhesion strength increases with MMT clay concentration up to about 6 wt %. Afterwards the adhesion strength appears to be at a plateau.

FIG. 4b shows the concentration-dependent and substrate-specific underwater (salt water) performance of adhesives made from zein-tannic acid-MMT-am and crosslinked with extra FeCl₃. Lap shear testing was done after the substrate on the application of the composition was kept for 24 hours, one week, and two weeks in salt water. The substrate dependence of adhesion strength for one individual sample composition suggests that the adhesive performs best on wood, although the wood was soaked in salt water prior to adhesive application. The adhesive becomes stronger over time, and the salt water is clear after one week.

The adhesive performance of the composition comprising (i) zein, (ii) tannic acid, (iii) MMT-am, and (iv) FeCl₃ was compared with the composition comprising (i) catechol, (ii) zein, (iii) MMT-am, and (iii) FeCl₃. With the composition comprising catechol, the salt water turned black after 24 hours, and after one week, at least some of the catechol within the adhesive leaked out. Lap shear testing was done after 24 hours and one week in salt water. With catechol, the glue darkens over time. For both compositions, low viscous samples with low clay concentrations are harder to apply to bronze substrates under salt water. More glue was needed to prepare one adhered pair since glue floats away easily. At the same composition or ratio of ingredients, the performance of catechol-comprising adhesive compositions is weaker when compared to the tannic acid-comprising adhesive compositions. Tannic acid does not leak out into the salt water. Increasing the clay concentration leads to better performance under salt water.

In some embodiments, provided is an underwater adhesive composition comprising (i) a zein, (ii) a tannic acid, and (iii) a natural polymer.

In some embodiments, the adhesive composition can further comprises FeCl₃.

The adhesive composition can still further comprises alcohol and water and is viscous, wherein the viscosity of the composition ranges from low to high, or the composition is in a solid form.

The natural polymer used in the adhesive composition can be protein or polysaccharides. Examples of polysaccharides include, but are not limited to, cellulose derivatives, such as (hydroxypropyl)methyl cellulose (HPM), methylcellulose (M Cell), α-cellulose (α Cell), and Avicel PH-101. Examples of protein include, but are not limited to, casein, albumin, soy, gelatin, mucin, or any combination thereof. The soy protein can be selected from soybean flour, soy protein isolate, and soy protein acid hydrolysate.

Table 4 shows the underwater adhesive compositions comprising (i) zein, (ii) tannic acid, (iii) FeCl₃, and natural polymer in various ratios (as grams in solution form and as wt % in a dry solid form of the adhesive composition). After application under salt water, the adhesives may contain some ethanol and water.

TABLE 4

| In ca. 5-10 g Ethanol-Water | | | Dry Solid Content or Ratio | | |
|---|---|---|---|---|---|
| Zein, | Tannic Acid | Polymer | Zein | Tannic Acid | Polymer |
| g | g | g | wt % | wt % | wt % |
| 2.2 | 3 | 0 | 42.31 | 57.69 | 0.00 |
| 2.2 | 3 | 0.1 | 41.51 | 56.60 | 1.89 |
| 2.2 | 3 | 0.5 | 38.60 | 52.63 | 8.77 |
| 2.2 | 3 | 1 | 35.48 | 48.39 | 16.13 |
| 2.2 | 3 | 2 | 30.56 | 41.67 | 27.78 |
| 2.2 | 3 | 3 | 26.83 | 36.59 | 36.59 |
| 2.2 | 3 | 4 | 23.91 | 32.61 | 43.48 |
| 2.2 | 3 | 5 | 21.57 | 29.41 | 49.02 |

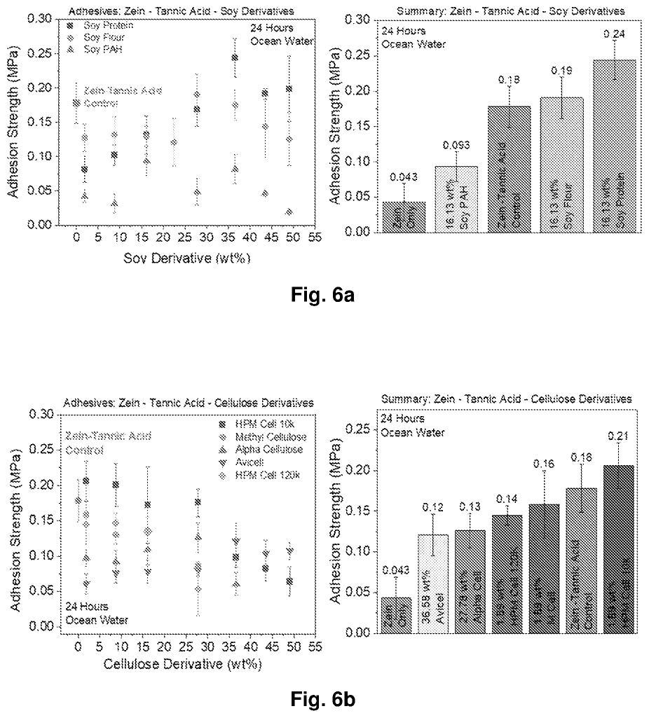

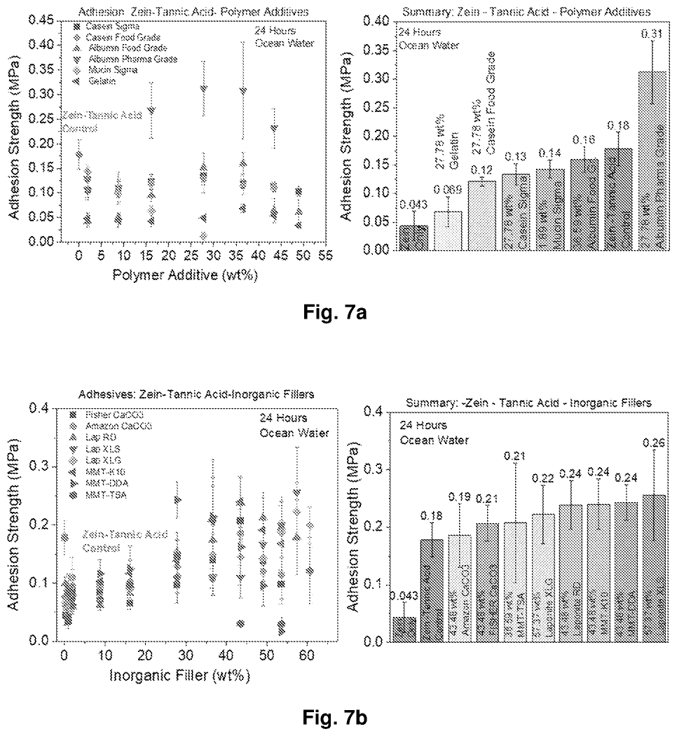

The underwater adhesive composition comprising (i) zein, (ii) tannic acid, and (iii) natural polymer was applied under ocean water onto bronze substrates and left there for 24 hours before lap shear testing. FIG. 6a, FIG. 6b, and FIG. 7a, show adhesion strength for the adhesive composition comprising polymers selected from soy derivatives, cellulose derivatives, casein, and albumin, respectively. The x-axis represents the amount of polymer in weight % of dry solid in an underwater adhesive composition. HPM, soy protein, and albumin show maximum adhesion strength. The composition comprising soy protein had a maximum adhesive value of about 0.24 MPa, whereas the composition comprising albumin had a maximum adhesive value of about 0.31 MPa.

Provided is a method of preparing zein-tannic acid based underwater adhesive compositions, which method comprises:
a. preparing a zein stock solution by mixing the zein with a solution containing alcohol and water;
b. adjusting the pH of the zein solution to 8-11;
c. mixing the zein solution with a tannic acid in the presence of alcohol to obtain a highly viscous formulation;
d. optionally adding FeCl₃; and
e. mixing the highly viscous formulation with an inorganic filler, a natural polymer, or a combination thereof in the presence of alcohol to obtain an opaque, a coacervate, a paste, or a putty-like mixture.

The affinity of adhesive compositions comprising zein and tannic acid for underwater or wet surface adhesion can be related to the amount and the many functional groups of tannic acid and, in some way, to the optimal zein-tannic acid compositions not being soluble in water. For example, once a viscous adhesive blob (e.g., a spatula full) was applied to an adherend surface underwater, a solid and thin polymer membrane formed immediately because the zein is not water-soluble. The membrane was yellow, opaque, and visible. For all samples applied underwater, this membrane protects the inside of the adhesive blob that is attached to the adherend. When the blob is squeezed between two adherend pairs, the membrane can rupture, and sandwiched adhesive covers both adherents. The sandwiched glue has time to interact with the adherend surfaces without the presence of much water. The liquid adhesive cures and hardens at the interface with water (i.e., at the edges around the sandwich), and then, as the water penetrates through the glued area and interacts with the zein and tannic acid, the inside glue is slowly cured and hardened as well. The 24-hours time period that the glue is kept under salt water is sufficient to harden most of the glue in a reproducible manner. The longer the sample is kept underwater, the more the glue hardens.

After the application of the adhesive composition to the substrates underwater or on the wet surface, water slowly diffuses into the adhesive, and the solvent, such as ethanol/water from the adhesive composition, diffuses out of the adhesive at the water/adhesive interface. Once the viscous adhesive composition is exposed to water, a solid zein-tannic acid containing membrane forms immediately, irrespective of the type of water used. The diffusion at this membrane influences the solvent content of the underwater adhesive. Because zein is not soluble in water, the liquid adhesive cures and hardens at the interface with water first, and then, as the water penetrates into the glue and interacts with the zein, the inside glue is cured/hardened. This hardening effect allows for aligning the adherends underwater and for adjusting the glued surface area to a desired size.

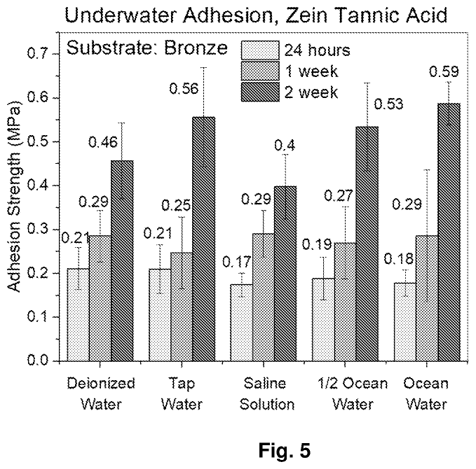

Five different types of water have been tested (see FIG. 5). The type of water appeared not to significantly influence the adhesion strength. However, the color of the water changed. The tap water and deionized water baths were brown and turbid, while the salt water was dirty but remained clear. The adhesive was applied underwater and kept underwater for 24 hours, one week, and two weeks, respectively. It was observed that, when a spoonful of adhesive (e.g., a 2 cm diameter blob) was applied under salt water for 24 hours and then broke apart, a hard and brittle surface formed, which broke easily but had a gum-like phase and a soft, viscous inside. The glue in the middle looked like it was freshly prepared. After a similar-sized blob was left for one week in salt water, the adhesive was cured completely and brittle throughout.

FIG. 5 illustrates the adhesion strength (in MPa) versus the water type and also versus the time left in that water. The data suggest that adhesion strengths are similar for all types of water used. Adhesion increased significantly with the time the adherends were left in water. For example, adhesion strength observed in ocean water tripled after two weeks. Indiana tap water had a similar effect on increasing adhesion, suggesting that the additional amount of salt in ocean water did not significantly influence adhesion strength.

A combination of cohesive and adhesive failure was observed for all samples after lap shear testing with patches of adhesive and “adhesive-free” areas on each adherend. The type of water did not influence the failure mode but the adhesive removed from the adherends became harder and more brittle the longer the adhesive remained in water.

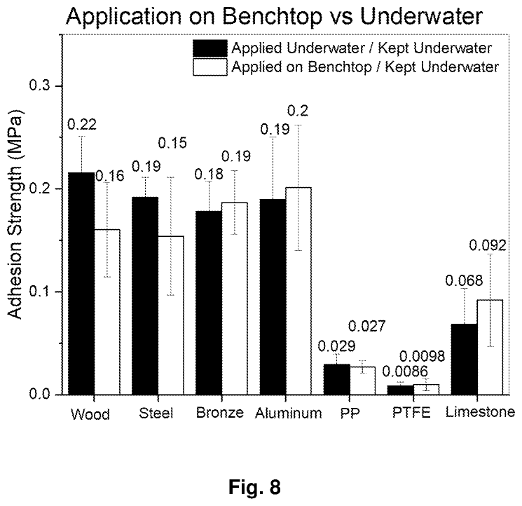

All the adhesive compositions of the present disclosure can be applied to the substrates underwater or on a benchtop to a wet surface first and then placed underwater. FIG. 8 shows that metal and wood substrates performed equally well for both underwater and benchtop application conditions, and the adhesion strengths were similar as well. Adhesion on limestone was weaker and about half the strength of the adhesion on-metal substrates. Adhesion to PP and PTFE was significantly different from the other surfaces but very weak, no matter under what conditions the adhesive was applied.

The adhesive compositions were designed to be applied and perform well underwater or on wet surfaces. However, because some products require the adhesive to be used in more than one way, both in-water and out-of-water application conditions and temperature conditions were compared and evaluated. At the lowest measured temperatures, applying the adhesive out-of-water, i.e., on a benchtop, and then placing the adherend in 5° C. ocean water for 24 hours, led to lower adhesion strength (out: 0.04±0.01 MPa) when compared to the in-water application (in: 0.11±0.02 MPa). Surprisingly, at about 21° C. no significant difference was observed between in-water application (in: 0.18±0.03 MPa) versus out-of-water application of adhesives (out: 0.19±0.03 MPa). At about 60° C. the adhesive performed much better when applied in-water (in: 0.30±0.13 MPa) than when applied on a benchtop first and then placed in ocean water (out: 0.12±0.08 MPa). As expected, the results confirmed that, at different temperatures, an adhesive that is specifically formulated for being applied underwater does not necessarily do as well when applied on a benchtop. These results showed how important the exact description of sample preparation conditions was, especially when comparing underwater adhesion data obtained from the literature.

The adhesive strength of all the adhesive compositions was tested at different temperatures. The compositions showed better adhesion at room temperature than at lower temperatures. Temperature is an important parameter in designing underwater or wet surface adhesives for applications that are not necessarily used at room temperature. For example, in packaging applications, storing selected samples at 4° C., refrigerator temperature might be critical to increasing the shelf life of products and preventing spoilage and mold growth. Performance at 37° C. is important for biomedical adhesives used on wet skin or in the oral environment. Performance at 40-60° C. might be relevant for working conditions or applications on a hot day outside.

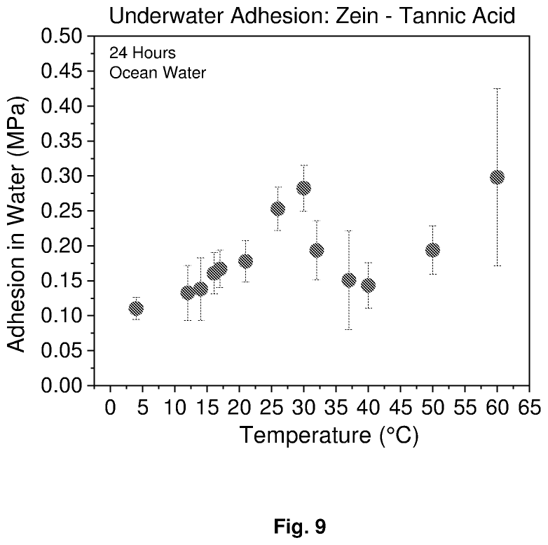

The results of adhesion are strongly dependent on the order of steps used for the application and curing of adhesives at the different temperatures underwater. FIG. 9 summarizes the temperature-dependent underwater adhesive performance of adhesive compositions comprising about 42 wt % zein: 58 wt % tannic acid (dry ratio) and ethanol/water at temperatures ranging from about 5° C. to about 60° C. under ocean water. The adhesives were applied to the substrates underwater at individual temperatures and then left there for 24 hours. Each adherend pair was lap shear tested immediately after being removed from the water. Special care was taken not to pre-stress the sandwiched adhesive, while fixing the adherend to the Instron for lap shear testing. The adhesives were hard but brittle, and pre-stressing of any kind induced cracks into the sandwiched glue.

FIG. 9 suggests a near linear increase in adhesion strength from 0.10 MPa-0.28 Mpa with temperature and an adhesion maximum at about 0.28 Mpa. This maximum adhesion strength can be related to optimal curing conditions for the adhesive composition. It was observed that, when the adhesive composition was immersed in ocean water at 30° C., viscosity decreased immediately, and the sample floated away if not caught between substrates. After a few seconds, the viscosity increased, and the adhesive composition appeared to consist of heterogeneous low viscous and higher viscous parts. At this point, the adhesive composition must be applied and aligned fast with the substrate before hardening starts. The adhesion strength decreased until about 35-40° C., where after adhesion strength increased again. The decrease in adhesion can be related to the changes in curing conditions while the adhesive was exposed to ocean water. The following increase in adhesion observed at the highest temperatures (e.g., 60° C.), was probably influenced by accelerated curing and more extensive denaturation of the zein protein. At high temperatures, the error bars were larger because the handling of adhesive in hot water becomes unpleasant.

### EXPERIMENTAL

The following examples serve to illustrate the present disclosure. The examples are not intended to limit the scope of the claimed invention.

### Materials:

Corn zein protein-Sigma, Flozein
Tannic acid (Sigma)
CaCO₃ (Marble White 200 Limestone A-17-274-31)
Casein (Sigma)

### Zein Stock Solution

Clear and amber-colored zein stock solutions were prepared by vigorously mixing zein powder (55.5 g) with a solution containing ethanol (45 g, 95% or 99%) and water (23 g, distilled or tap water). A premixed solution of ethanol and water was prepared to get an amber and a clear zein solution because zein does not dissolve in water; adding water first and then ethanol would lead to a heterogeneous mixture or slurry with many hardened zein clumps that will not easily dissolve. Sodium hydroxide (4 g, 10 M NaOH) solution was added to the zein solution under mixing to adjust the pH to 9-11. The resulting highly viscous zein solutions were all clear (see-through) and with different shades of amber. The shades of amber vary depending on the zein batch.

### A. Zein-Tannic Acid Adhesive Composition

1. Zein-tannic acid adhesive formulation was prepared by mixing the prepared zein stock solution (5 g of a solution containing about 2.2 g of dry zein powder) with tannic acid powder (1 g). Extra ethanol can be added while mixing as necessary to obtain a highly viscous putty or thick gel-like substance or a thick solution/dispersion. The adhesive is ready for application once it pulls the fibers.

2. Zein-tannic acid adhesive formulation was prepared by mixing the prepared zein stock solution (5 g of a solution containing about 2.2 g of dry zein powder) with tannic acid powder (3 g) and FeCl₃ (0.001 g). Extra ethanol can be added while mixing as necessary to obtain a highly viscous putty or a thick solution/dispersion. The adhesive is ready for application once it pulls the fibers.

B. Zein-Tannic Acid-CaCO₃-Casein-FeCl₃ Adhesive Composition

(i) A zein stock solution (5 g) was first mixed with tannic acid powder (1 g) and FeCl₃ (0.001 g, dissolved in water). Ethanol was added to the mixture until it formed a highly viscous and translucent amber-colored solution. The pH was adjusted to about 9. (ii) CaCO₃ (1 g) powder was added to the highly viscous zein-tannic acid solution together with more ethanol to wet and manually mix the powder into the solution. The resulting mixture is opaque, coacervate-like or paste-like, or putty-like. (iii) Casein (1 g) was added to the coacervate-like or paste-like, or putty-like formulation with more ethanol to yield a thick and sticky dispersion or paste that becomes more viscous with time (about 10 minutes). The viscosity of the zein-tannic acid-CaCO₃-casein containing paste/putty can be adjusted by adding more ethanol. The coacervate-like inhomogeneous character of the adhesive was observed after adding larger amounts of ethanol. The resulting adhesive was applied to metal adherends with spatula under salt water. Table 1 shows the adhesive compositions prepared by varying amounts of CaCO₃ and casein.

Adhesion tests were conducted to evaluate the adhesive properties of the adhesive compositions.

### C. Zein-Tannic Acid-FeCl₃-MMT-am Adhesive Composition

(i) A zein stock solution (5 g) was first mixed with tannic acid powder (1 g) and FeCl₃ (0.001 g, dissolved in water). Ethanol was added to the mixture until it formed a highly viscous and translucent amber-colored solution. The pH was adjusted to about 8-9. (ii) Montmorillonite clay, MMT-am (0.20 g, 6 wt %) powder, was added to the highly viscous zein-tannic acid solution together with more ethanol to wet and manually mix the powder into the solution. The resulting mixture was opaque, coacervate-like or paste-like, or putty-like.

### D. Zein-Tannic Acid-Polymer Material

A zein stock solution (5 g solution) was first mixed with tannic acid powder (3 g). Ethanol was added to the mixture until it formed a highly viscous and translucent amber-colored solution. The pH was adjusted to about 8-9. (ii) Polymer powder (between 0.1-5 g) was added to the highly viscous zein-tannic acid solution together with more ethanol to wet and manually mix the polymer powder into the solution. The resulting mixture is opaque, coacervate-like or paste-like, or putty-like. The mixture can be diluted with more ethanol if desired. The polymer can be a soy derivative or a cellulose derivative, or another polymer such as casein, mucin, gelatin, or albumin.

Application of Adhesive composition on the substrates:

Aluminum, stainless steel, and bronze are the metal substrates that were used for lap shear testing (e.g., FIG. 2). All metal surfaces were polished before applying adhesive underwater. Wood and limestone are natural substrates; these were used as received. The synthetic polymer surfaces tested were polytetrafluoroethylene (PTFE) and polypropylene (PP). Zein-tannic acid adhesive solution/dispersion or putty was applied with a spatula under water (e.g., ocean water) directly onto the substrates. Usually, a 0.7 cm large blob of adhesive was smeared onto one of the adherends placed underwater. Two substrates with one blob of glue in between were overlapped and glued together. Then the adherends were aligned and left under water for 24 hours before lap shear testing. If possible, excess glue was removed from the adherend surfaces right after application. After application, the adhesive-covered edges exposed to salt water hardened quickly, and the sandwiched adhesive hardened slowly with time. Twenty-four hours were sufficient for most of the adhesive sandwiched between adherends to become hard. After curing in water, the adherend pairs were removed from the water bath, and lap shear was tested immediately without breaking off the little excess glue that might have leaked out on the side of the adherends. Between 6 and 10 adherend pairs were prepared for each formulation to be tested. The different types of water used in the water bath (see FIG. 5) were deionized water, Indiana tap water, saline solution, ½ ocean water (that is ocean water with half the salinity), and ocean water. The typical pH of ocean water ranges between a pH of 7.5 to 8.1, depending on location.

Lap-shear-testing:

An Instron 5544 Materials Testing System with a 2000 N load cell was used for lap shear experiments and for quantifying bond strength. The substrate or adherend dimensions were 1.2 cm×10 cm, and the overlap areas were 1.2×1.2 cm most of the time. Substrates were pulled apart at 2 mm per minute. At least 5 adherend pairs for every adhesive composition and control were lap shear tested, and averages with standard deviations were reported. Because adhesive was applied underwater, the glued overlap areas were not always perfect 1.2 cm×1.2 cm squares. These imperfect overlap areas needed to be measured after lap shear testing, and the corrected areas were used for calculating adhesion strength for each adherend pair.

In addition, any of the embodiments described in the following clause list are considered to be part of the invention.

A. An underwater adhesive composition comprising (i) a zein, and (ii) a tannic acid, wherein the composition comprises about 30-80 wt % of tannic acid.

B. The underwater adhesive composition of clause A, wherein the ratio of zein to tannic acid is about 42 wt %:58 wt % of dry solid.

C. The underwater adhesive composition of clause A or B, wherein the composition further comprises ferric chloride (FeCl₃).

D. The underwater adhesive composition of clause A, wherein the composition further comprises alcohol and water and is viscous, or the composition is in a solid form.

E. An underwater adhesive composition comprising (i) a zein, (ii) a tannic acid, and (iii) an inorganic filler.

F. The underwater adhesive composition of clause E, wherein the composition further comprises ferric chloride (FeCl₃).

G. The underwater adhesive composition of clause E or F, wherein the inorganic filler is selected from natural clay, synthetic clay, calcium carbonate, or any combination thereof.

H. The underwater adhesive composition of clause G, wherein the inorganic filler is selected from Montmorillonite (MMT-K10); Montmorillonite, dimethyl dialkyl amine (MMT-DDA or MMT-amine); Montmorillonite, trimethyl stearyl ammonium (MMT-TSA or MMT-am); Laponite RD; and calcium carbonate.

I. The underwater adhesive composition of clause E or F, wherein the amount of inorganic filler is about 6 wt % of dry solid composition.

J. The underwater adhesive composition of clause E, wherein the composition further comprises alcohol and water and is viscous, or the composition is in a solid form.

K. An underwater adhesive composition comprising (i) a zein, (ii) a tannic acid, (iii) an inorganic filler, and (iv) a natural polymer.

L. The underwater adhesive composition of clause K, wherein the composition further comprises FeCl₃.

M. The underwater adhesive composition of clause K or L, wherein the inorganic filler is selected from natural clay, synthetic clay, calcium carbonate, or any combination thereof.

N. The underwater adhesive composition of clause M, wherein the inorganic filler is selected from Montmorillonite (MMT-K10); Montmorillonite, dimethyl dialkyl amine (MMT-DDA or MMT-amine); Montmorillonite, trimethyl stearyl ammonium (MMT-TSA or MMT-am); Laponite RD; and calcium carbonate.

O. The underwater adhesive composition of clause K or L, wherein the natural polymer is a protein or a polysaccharide.

P. The underwater adhesive composition of clause O, wherein the protein is selected from casein, albumin, soy, gelatin, mucin, or any combination thereof.

Q. The underwater adhesive composition of clause O, wherein the polysaccharide is a cellulose derivative.

R. The underwater adhesive composition of clause Q, wherein the cellulose derivative is selected from (hydroxypropyl)methyl cellulose, methyl cellulose, α-cellulose, and Avicel pH-101.

S. The underwater adhesive composition of clause K or L, wherein the inorganic filler and the natural polymer are in a ratio of about 1:1 wt/wt.

T. The underwater adhesive composition of clause K, wherein the composition further comprises alcohol and water and is viscous, or the composition is in a solid form.

U. An underwater adhesive composition comprising (i) a zein, (ii) a tannic acid, and (iii) a natural polymer.

V. The underwater adhesive composition of clause U, wherein the composition further comprises FeCl₃.

W. The underwater adhesive composition of clause U or V, wherein the natural polymer is a protein or a polysaccharide.

X. The underwater adhesive composition of clause W, wherein the protein is selected from casein, albumin, soy, gelatin, mucin, or any combination thereof.

Y. The underwater adhesive composition of clause W, wherein the polysaccharide is a cellulose derivative.

Z. The underwater adhesive composition of clause Y, wherein the cellulose derivative is selected from (hydroxypropyl)methyl cellulose, methyl cellulose, α-cellulose, and Avicel pH-101.

A′. The underwater adhesive composition of clause U, wherein the composition further comprises alcohol and water and is viscous, or the composition is in a solid form.

B′. A method of preparing an underwater adhesive composition comprising a zein and a tannic acid, which method comprises:
a. mixing a zein stock solution with a tannic acid, in the presence of alcohol to obtain a highly viscous formulation;
b. adjusting the pH to about 8-11; and
c. mixing the highly viscous formulation with an inorganic filler, a natural polymer, or a combination thereof in the presence of alcohol to obtain a coacervate or a paste, or a putty-like adhesive composition.

C′. The method of clause B′, wherein the method further comprises adding FeCl₃ in step (a).

D′. The method of clause B′, wherein the zein stock solution is prepared by mixing a zein with a solution containing alcohol and water and adjusting the pH of the zein solution to 8-11.

E′. The method of clause B′ or D′, wherein the alcohol is ethanol.

Various modifications and variations of the described compositions, methods, and uses of the technology will be apparent to those skilled in the art without departing from the scope and spirit of the technology as described. Although the technology has been described in connection with specific exemplary embodiments, the invention, as claimed, should not be unduly limited to such specific embodiments. Indeed, various modifications of the described modes for carrying out the invention that are obvious to those skilled in the art are intended to be within the scope of the following claims.

1. An underwater adhesive composition comprising (i) a zein, and (ii) a tannic acid, wherein the composition comprises about 30-80 wt % of tannic acid.

2. The underwater adhesive composition of claim 1, wherein the ratio of zein to tannic acid is about 42 wt %:58 wt % of dry solid.

3. The underwater adhesive composition of claim 1, wherein the composition further comprises ferric chloride (FeCl₃).

4. The underwater adhesive composition of claim 1, wherein the composition further comprises alcohol and water and is viscous, or the composition is in a solid form.

5. An underwater adhesive composition comprising (i) a zein, (ii) a tannic acid, and (iii) an inorganic filler, a natural polymer, or both inorganic filler and a natural polymer.

6. The underwater adhesive composition of claim 5, wherein the composition further comprises ferric chloride (FeCl₃).

7. The underwater adhesive composition of claim 5, wherein the inorganic filler is selected from natural clay, synthetic clay, calcium carbonate, or any combination thereof.

8. The underwater adhesive composition of claim 7, wherein the inorganic filler is selected from Montmorillonite (MMT-K10); Montmorillonite, dimethyl dialkyl amine (MMT-DDA or MMT-amine); Montmorillonite, trimethyl stearyl ammonium (MMT-TSA or MMT-am); Laponite RD; and calcium carbonate.

9. The underwater adhesive composition of claim 5, wherein the amount of inorganic filler is about 6 wt % of dry solid composition.

10. The underwater adhesive composition of claim 5, wherein the composition further comprises alcohol and water and is viscous, or the composition is in a solid form.

11-14. (canceled)

15. The underwater adhesive composition of claim 5, wherein the natural polymer is a protein or a polysaccharide.

16. The underwater adhesive composition of claim 15, wherein the protein is selected from casein, albumin, soy, gelatin, mucin, or any combination thereof.

17. The underwater adhesive composition of claim 15, wherein the polysaccharide is a cellulose derivative.

18. The underwater adhesive composition of claim 17, wherein the cellulose derivative is selected from (hydroxypropyl)methyl cellulose, methyl cellulose, α-cellulose, and Avicel pH-101.

19. The underwater adhesive composition of claim 5, wherein the inorganic filler and the natural polymer are in a ratio of about 1:1 wt/wt.

20-27. (canceled)

28. A method of preparing an underwater adhesive composition comprising a zein and a tannic acid, which method comprises:
a. mixing a zein stock solution with a tannic acid, in the presence of alcohol to obtain a highly viscous formulation;
b. adjusting the pH to about 8-11; and
c. mixing the highly viscous formulation with an inorganic filler, a natural polymer, or a combination thereof in the presence of alcohol to obtain a coacervate or a paste or a putty-like adhesive composition.

29. The method of claim 28, wherein the method further comprises adding FeCl₃ in step (a).

30. The method of claim 28, wherein the zein stock solution is prepared by mixing a zein with a solution containing alcohol and water and adjusting the pH of the zein solution to 8-11.

31. The method of claim 28, wherein the alcohol is ethanol.
